(19) United States
(12) Patent Application Publication
(10) Pub. No.: US 2014/0090365 A1
(43) Pub. Date: Apr. 3, 2014

(54) Apparatus and Method for Converting Movement into Energy

(71) Applicant: Michele Grassi, Forte dei Marmi (IT)

(72) Inventor: Michele Grassi, Forte dei Marmi (IT)

(73) Assignee: MATHCLICK LIMITED, London (GB)

(21) Appl. No.: 14/112,612

(22) PCT Filed: Apr. 17, 2012
(86) PCT No.: PCT/GB2012/050845

§ 371 Date: Dec. 16, 2013

(30) Foreign Application Priority Data
Apr. 18, 2011 (GB) 1106554.7

(51) Int. Cl. F03B 13/18

(52) U.S. Cl. CPC F03B 13/1815
USPC 60/327; 60/506

(57) ABSTRACT

Apparatus for converting movement into energy, comprising a buoyant or floating body fully (1,9,11) submerged in a fluid medium. The buoyant body is supported in the fluid by a buoyancy or similar force acting in a first direction. A connecting or mooring line connects the buoyant body (1,9,11) to a pivot point displaced from the buoyant body in the direction from which the buoyancy or similar force acts on the buoyant body, and formed by a counter-weight (2). The apparatus also includes at least one power or energy take-off line (3) separate from the connecting or mooring line to convert movement of the buoyant body into energy.

The present invention is concerned with an oscillating body subjected to a force and the conversion of the movement of that body into useable energy. Particular embodiments of the invention are concerned with offshore wave energy converters used to generate electricity from the movement of water associated with waves in or through water. However, the invention works for any floating body (e.g. a kite hovering in the air, or a magnet suspended in the air by the push of a magnetic field).

A number of different types of offshore wave energy converters have been proposed. The known devices for wave energy conversion (see “Wave Energy Utilization: A Review of the Technologies” Falcão, in “Renewable and Sustainable Energy Reviews 14 (2010) 899-918) are based on one of three working principles: oscillating water column devices, oscillating body (or bodies) devices and over-topping devices. The present invention is concerned with an oscillating body device. Such devices convert or capture energy from a body oscillated by waves.

Oscillating body devices typically use one of the following working principles:
1) Mostly floating devices (either single devices or multiple interlinked devices) moving up and down or sideways on the water surface.
2) Mostly static devices extracting energy from the pressure variation or surge induced by a passing wave. This includes oscillating water column devices, flexible devices and barrage devices.
3) Mostly or wholly underwater devices which move with the water surrounding them (see, for example, WO 2008/065684 and WO 2010/115241).

A problem with the floating oscillating body devices is that these devices sit on the surface, exposed to the extremes of the wave climate at those locations. This means that two main objectives of a working device, survivability and power rating, may conflict with each other. High energy surface waves may make for higher levels of power or energy capture but those high energy waves may also damage the exposed device. The resulting compromises are both not robust and provide a low ratio of power rating to cost. Another problem with this approach is that as the main movement of these devices is linked to the wave height, there are practical limitations on the amount of resonance that you can use to increase power extraction. Finally, these machines need to be matched to the local wave climate where they are to be sited, and this limits the potential cost savings that one can reap from mass production of devices. These machines are furthermore very much dependent on the specific locations in which they are installed, again making standardized mass production and installation not realistic. Sophisticated dumping mechanisms must also be in place to avoid overextension during storms.

In the mostly static devices which extract energy from pressure variation or surges, the conflict between survivability and power rating is still present, but to a lesser extent, as the power extractor can be substantially at rest with respect to the wave, and therefore one can find ways to delink it from the waves: for example, via moorings, careful tuning of proper frequencies or by placing the device directly on the shore or on the ocean floor. However, in this category of devices, increasing the power rating usually means increasing the volume of the machine, and this poses a practical limit on the power ratings that one can achieve. Moreover, although it is easier to ensure survivability of a static structure, this becomes nevertheless very demanding from a technological point of view as the size approaches (or even surpasses) that of a ship. Very large static offshore structures are also very expensive to install and to maintain. Furthermore, these devices, like the floating ones, need to be optimized for the wave climate in which they are going to be installed, thus making real mass production less realistic.

The third device type in which the power or energy capture elements are mostly or wholly under water and essentially move with the water surrounding it, does not have in general the same problem of the contrasting goals of survivability and power rating. However, as the energy extraction happens mainly in the vertical direction, resonance has a very limited scope.

A problem with the known offshore wave energy converters is that they move or oscillate through short distances (relative to the wavelength of waves hitting them) with wave height being low relative to wavelength. A further particular problem of the devices on the surface is their vulnerability to bad weather. This means that they often cannot be used in big wave conditions when the waves have most energy as the devices may be damaged.

It is an object of the present invention to provide a wave energy converter in which these disadvantages are eliminated or reduced, or at least to provide a useful alternative.

The known wave energy converter devices effectively concentrate on acquiring energy from movement having a significant or predominant vertical component. The inventor of the subject application has realised that it is possible to significantly improve the energy capture of a wave energy converter by making use of (rather than restricting) horizontal movement.

The present invention provides apparatus for converting movement into energy, comprising: a buoyant or floating body fully submerged in a fluid medium, the buoyant body being supported in the fluid by a buoyancy or similar force acting in a first direction, a connecting or mooring line connecting the buoyant body to a point displaced from the buoyant body in the direction from which the buoyancy or similar force acts on the buoyant body, wherein the connecting or mooring line connects the buoyant body to a counterweight which forms the pivot, and the apparatus further includes at least one power or energy take-off line separate from the connecting or mooring line to convert movement of the buoyant body into energy. The counterweight is affected by weight or a similar force acting in a direction opposite to that acting on said buoyant or floating body.

The term “comprising” as used in this specification and claims means “consisting at least in part of”. When interpreting statements in this specification and claims which include the term “comprising”, other features besides the features preferred by this term in each statement can also be present. Related terms such as “comprises” and “comprised” are to be interpreted in similar manner.

The term “a” in the claims means “at least one”. When intepreting the claims which include the term “a” or a similar term, more than one instance of the feature preferred by this term may be present.

Embodiments of the arrangement are effectively pendulums generally pivoting about the point displaced from the buoyant body in the direction from which the buoyancy or similar force acts on the buoyant body. The inventor is the first to realise in the current context that creating a pendulum arrangement and extracting energy from the oscillation of the pendulum allows for the extraction of higher levels of energy than was previously possible.

The use of a counterweight allows one to create a pendulum arrangement with a buoyant body located a large distance from the ground or sea bed without the need for extremely long mooring lines. The use of a mobile or floating counterweight also means that the apparatus can be more easily deployed and moored than and/or would be the case if it were necessary to decouple the body from the ground or sea bed and then re-moor it at a different location on the ground or sea bed.

Preferably the at least one power or energy take-off line is a line whose orientation has a significant component orthogonal to the direction from which the buoyancy or similar force acts on the buoyant body.

This arrangement allows for take-off power or energy from the very substantial degree of movement of the pendulum arrangement in the direction orthogonal to the direction from which the buoyancy or similar force acts on the buoyant body.

Preferably, the buoyancy or similar force acts on the buoyant body in a substantially vertical direction and the power or energy take-off line runs between the buoyant body and an energy take-off line fixing point displaced from the buoyant body in a direction having a significant horizontal component.

Preferably, the connecting or mooring line connects the buoyant body to a point below the buoyant body and thereby forms an inverted pendulum.

Preferably, there are at least three power or energy take-off elements.

Preferably, the connecting or mooring line moors the buoyant body to a counterweight hanging below the buoyant body.

Creating an inverted pendulum allows for the easy extraction of high levels of energy with an easy to install apparatus.

Preferably, the connecting or mooring line may, when in use, be kept at a substantially constant length.

Preferably, the length of the connecting or mooring line may be controllably changed.

The frequency of oscillation of a pendulum is proportional to the square root of its length. Changing the length of the connecting or mooring line therefore allows one to controllably change the frequency at which the apparatus would resonate and thereby allow one to tune the apparatus to match different wave frequencies or wave conditions.

Preferably the buoyant body is larger than the counterweight and the combination of the buoyant body and counterweight is positively buoyant. The combination may also be negatively buoyant, or substantially neutrally buoyant in alternative embodiments.

Preferred embodiments of the present invention consist in a method for inducing a natural frequency of horizontal oscillation of desired value and increased intensity in a totally submerged positively buoyant object.

Such a result may be obtained by appending a tensioned link to such an object, while correspondingly increasing its buoyancy to balance the added weight, by acting either on itself or on the mooring system (although such an action is not part of the present invention). This link must have its lower attachment point with limited horizontal movements, while the movements in the direction of the axis of the link itself (which could be a rope passing through a fixed point or stabilized deviation system) can be allowed, as long as there is a way to stabilize the average vertical position of the floater itself by some means. The tension on such a link can be achieved for example by attaching to its lower end a counterweight, or a floater directed again upwards, or by the use of a winch connected to a torque motor. Another method to achieve the same result is by replacing the counterweight with an attachment point linked firmly to a stable structure (which could be the ground), possibly in a way which allows vertical movements. Such an arrangement could be replicated in an array or micro-array of individual buoyant bodies.

Preferred embodiments of the present invention aim to increase the magnitude of the movement of the buoyant body or energy point absorber and to also increase the device's potential for resonance. The described embodiments are completely submerged point absorber type device in which the device is helped to “surf” the pressure wave associated with passing water or air or seismic waves. The term point absorber makes reference to the fact that the apparatus absorbs or receives energy at a single element; the buoyant body. The buoyant body is the point absorber.

Preferred point absorbers embodying the present invention are able to move with a speed which is many times larger than that of the forcing medium motion (i.e. the motion of the moving medium in which it sits), thus circumventing the limitation of being limited to the water particle speed or to only a vertical (and therefore very limited, due to the presence of the free surface of the water) enhancement. The motion of preferred embodiments of the invention is mainly horizontal, but some of this enhanced horizontal motion leaks also in the vertical direction. This much increased motion (and speed) in turn allows for an increase of power rating which is no longer linked only to increase in volume of the energy absorber, and furthermore it increases dramatically the scope of resonance. In tank tests the inventor verified gains (ratio between displacement of the point absorber and wave height) under resonance conditions of up to 14, which is completely unheard of in the world of wave energy generation, and in ocean hydraulics in general. This is another distinctive advantage with respect to the prior art. Even the current devices from the applicant (described in WO 2008/065684), which can, in certain circumstances, resonate both horizontally and vertically, cannot achieve the level of gain of preferred embodiments of the present invention due to their “grip” on the water which is a very significant damping on the resonance, and the fact that they would get out of the water at the beginning of the forcing, thus losing most of the potential for motion enhancement. Instead the augmented movement of preferred embodiments of the present invention is mainly in the horizontal directions, thus avoiding the risk of the point absorber or buoyant body being thrown out of the water altogether.

Another advantage of preferred embodiments of the present invention is that they can profit (depending on the value of their proper frequency of oscillation) from an increase in the wavelength of the incident waves with a fixed wave height, contrary to all other devices, thus being very efficient in deep offshore oceanic locations.

These advantages can be obtained by keeping the point absorber completely submerged, and decreasing significantly its horizontal inertia, by balancing its buoyancy with a counterforce which originates in a region which is allowed to have little or no movement, like a counterweight hanging several meters below the floater, or a direct link of the floater to the ocean floor. In this case the link can be of a kind allowing for variation in length, to allow for a tuning of the proper resonance period(s) of the floater and to allow it to be risen and lowered in response to changes in the sea state.

In the description of this specification reference may be made to subject matter which is not within the scope of the appended claims. That subject matter should be readily identifiable by a person skilled in the art and may assist in putting into practice the invention as defined in the appended claims.

Embodiments of the invention will now be described by way of non-limiting examples and with reference to the accompanying drawings, in which:

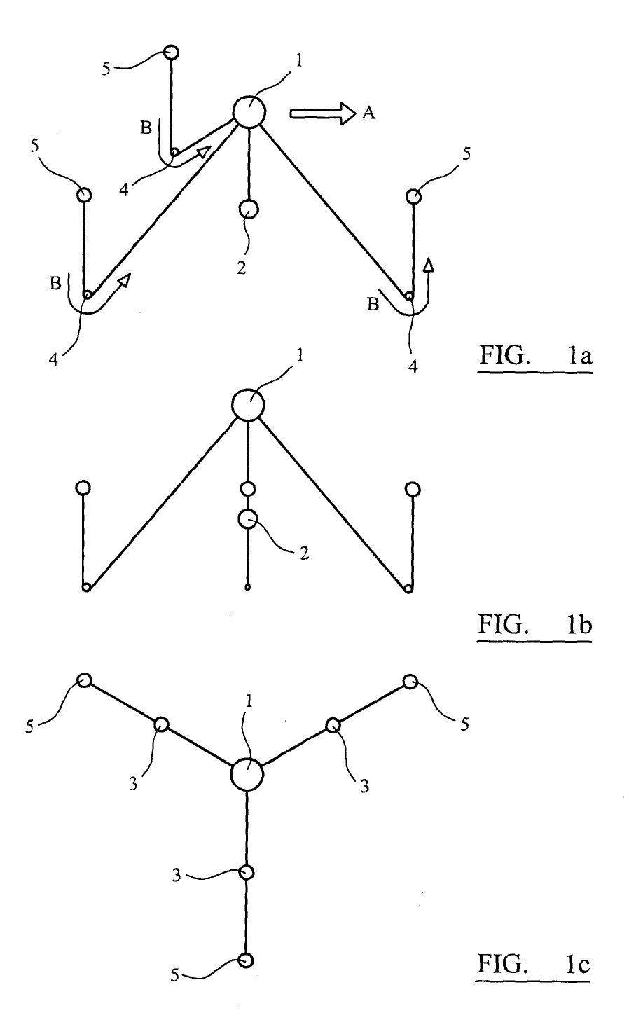

FIGS. 1a to 1c are, respectively, perspective, side and top plan views of a wave energy converter embodying the invention;

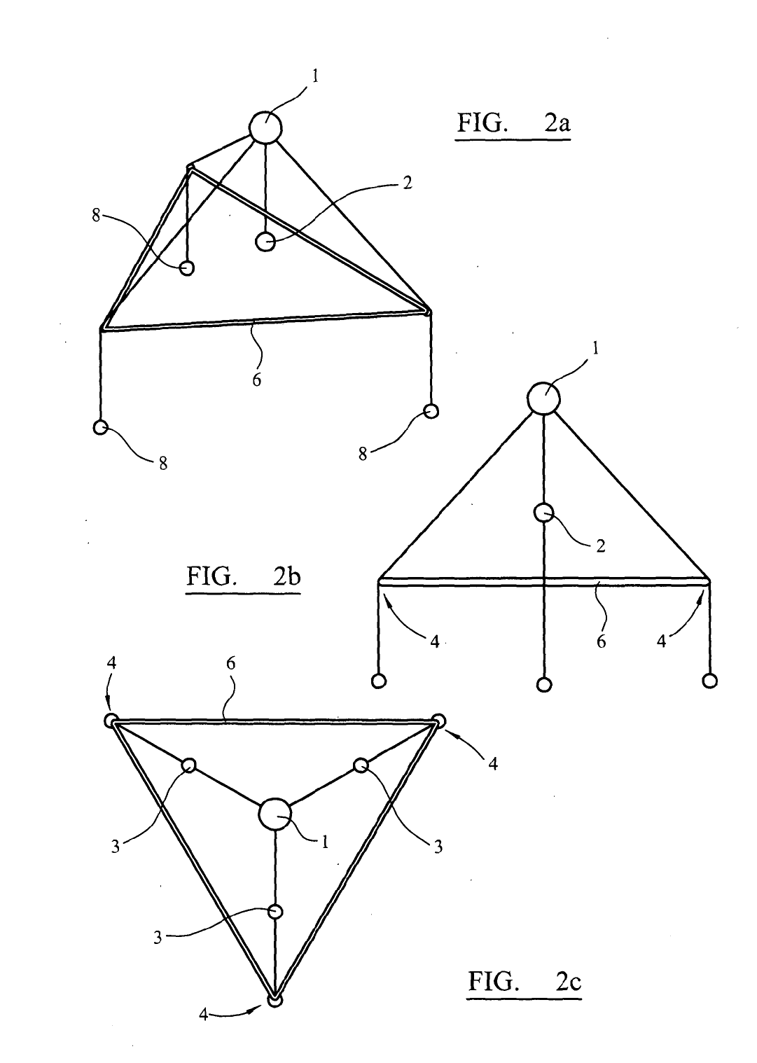

FIGS. 2a to 2c are, respectively, perspective, side and top plan views of an alternative wave energy converter embodying the invention;

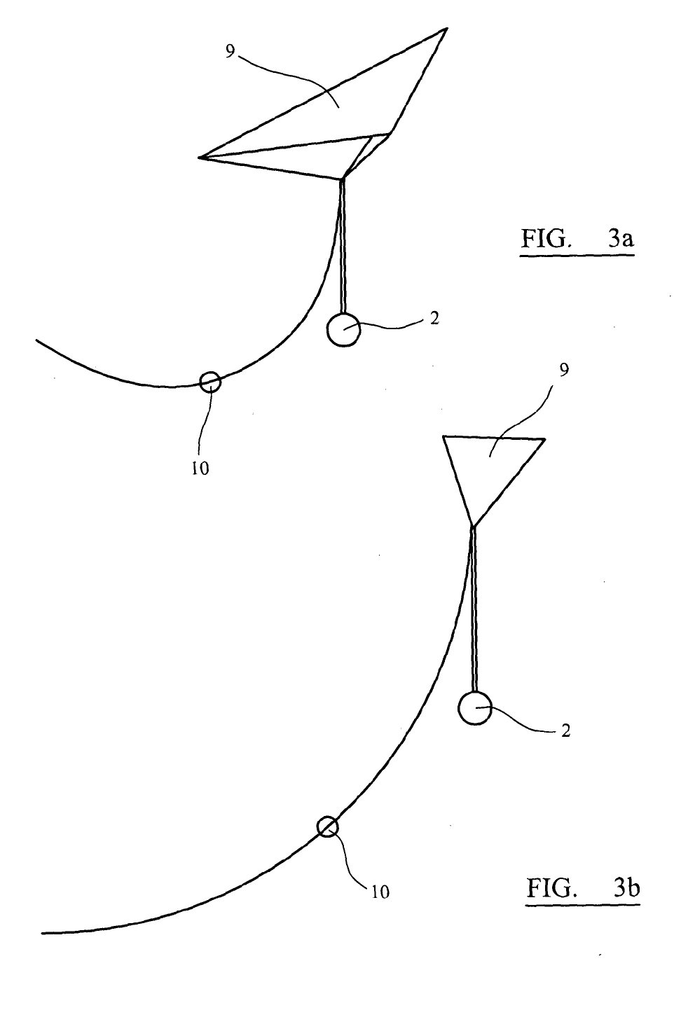

FIGS. 3a and 3b are, respectively, perspective and side views of a kite embodying the invention; and

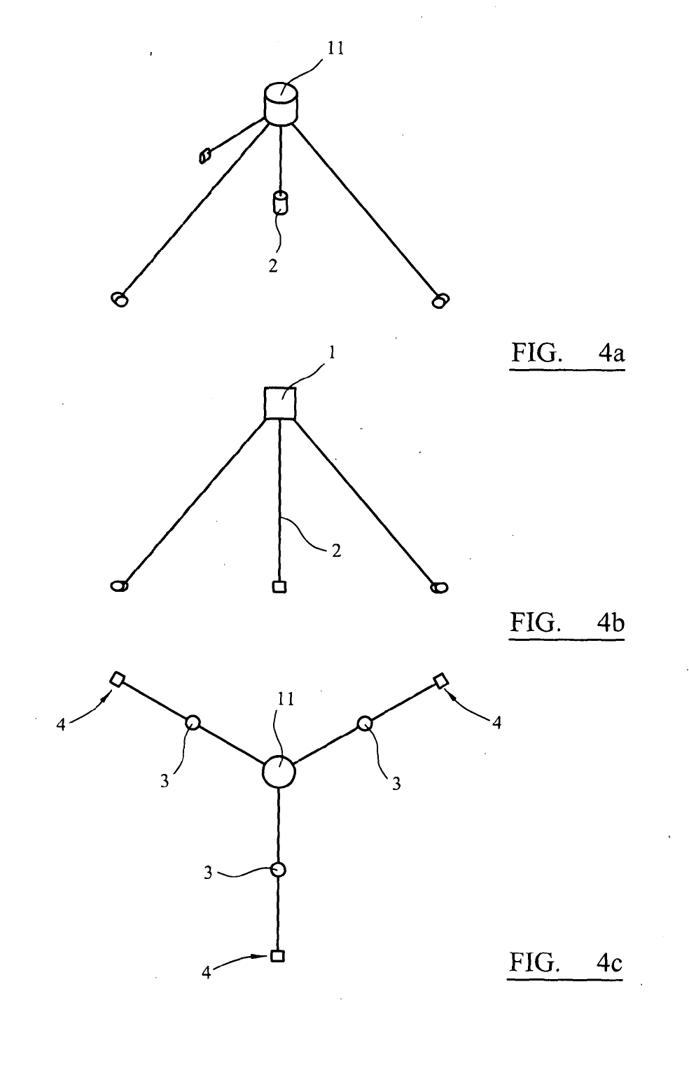

FIGS. 4a to 4c are, respectively, perspective, side and top plan views of a magnetically suspended oscillator embodying the invention.

Referring to FIGS. 1a to 1c, a buoyant or floating body (1) is linked to a counterweight (2) hanging below it. Both the floating body (1) and the counterweight (2) are fully submerged in a body of water subject to water waves. The buoyant body (1) is large relative to the counterweight (2). For example, the buoyant body would cause approximately 100 cubic meters of displacement and weigh around 10 tons with the counterweight being considerably smaller and heavier, displacing 20 cubic meters and weighting 100 tons, so that the system formed by the buoyant body (1) and the counterweight (2) as a whole is positively buoyant for 10 tons. Three cables (3) are connected to the floating body (1). Each of these cables is coupled to a power or energy take off point (4) below the floating body. The cables (3) are kept in tension by, for example, being connected to a buoy (5) or other positively buoyant element at the cable end distal to the floating body, providing (all three together) the tension necessary to balance the positive push of the system formed by the buoyant body and the counterweight and keep the buoyant body floating underwater at a fully submerged position. Movement of the floating body in, for example, the direction A shown in FIG. 1, results in movement in direction B of each of the cables in relation to their respective power take off points (4). This relative movement is used to generate power or energy using, for example, an arrangement similar to that disclosed in co-pending application GB 1016388.9, of which a copy is attached as Appendix A and whose contents are hereby incorporated by reference. Movement of a cable relative to a pulley or drum (not shown) at the power take-off point (4) causes the pulley or drum to spin. This spinning drives a shaft and thereby generates useable energy (usually electricity) in a manner well known to the skilled man.

Water wave energy converter embodiments of the invention make use of the fact that the energy of a water weight drops as one sinks deeper below the surface of the water. The buoyant body (1) is located at a much shallower depth than the counterweight (2). The counterweight (2) can therefore be considered to be substantially fixed relative to the buoyant body (1). The distance from the buoyant body (1) to the counterweight (2) could be for example 20 meters, and the depth of the water 50 meters, with the points (4) on the ocean floor.

The power take off units are generally static. In the embodiment illustrated in FIG. 1, they are on the sea floor. The power take-off points could also be on the buoyant body with the end of the cables distal from the buoyant body (1) and the proximal end of the cables being attached to buoys and wound around a power take off device at the buoyant body. The power take off could also be in the form of pistons positioned at either end of the cables (3), used to pump water or other fluids, or they could be linear generators used in place of the pistons to produce directly electricity.

The power take off system can be any one of the known devices for converting movement of a cable into energy. These include the devices used by 40South Energy Limited or the “Bristol cylinder”, or through a hinge mechanism either at the upper member or at the lower link, or through gyroscopic devices inside the upper member, or through other mechanisms which will be clear to the persons skilled in the technology.

The alternative embodiment of FIGS. 2a to 2c is identical to that of FIG. 1 except that the cables are fixed to a lower floating platform (6) rather than the sea floor. The cables (3) are also kept in tension by weights (8) rather than floats as in the arrangement of FIG. 1.

The single floating body devices shown in FIGS. 1 to 4 can be arranged in arrays of buoyant bodies or floaters (1).

In use, all four described wave energy converter embodiments effectively operate as an inverted pendulum. In use, and when acted upon by waves, the buoyant body (1) moves in a shallow ellipse with the most significant element of the motion being in substantially horizontal directions. The mooring point of FIG. 3, the counterweights of FIGS. 1 and 2, and the stabilisation arrangement act as the pendulum pivot around which the floating body oscillates in response to wave movements.

The frequency of oscillation of a pendulum is proportional to the square root of its length. This means that the frequency of oscillation of the floating body is a function of the length of the mooring line and can be varied by changing the length of the mooring line. An important advantage of the described embodiments is therefore their ability to be timed to match the frequency of ambient waves and thereby achieve a resonant condition.

FIGS. 3a and 3b illustrate a kite arrangement embodying the invention. The principle behind this is the same as that behind the wave energy converters discussed above except that the buoyant body in water is replaced by a floating kite (9) in air.

Regarding high altitude wind energy converters, they tend to be either in the form of kites or turbines suspended by the use of balloons, suspended with tethers to the ground.

In the kite case, power take-off happens from the pull and release of (some of) one or more tethers (10) connecting the kite to the ground, and from the turning of the kite in a carousel path in the air. The kite generates the desired movement by orchestrating its path in the air, through a control system which pilots it. In the illustrated embodiment of FIGS. 3a and 3b, by attaching a counterweight (2) to the kite itself, we provide it with a natural frequency of (mainly horizontal) oscillation. If such frequency matches that of the variability in wind intensity, the kite can resonate (horizontally) increasing very significantly its movement with respect to the ground, and therefore its power extraction capability.

For balloon suspended turbines (not shown), in an embodiment of the present invention, by attaching a counterweight below the balloon one can give it a natural frequency of (mainly horizontal) oscillation. If the frequency matches that of the variability in wind intensity, the whole apparatus acquires a significant extra movement, which can be used to increase the power take-off.

FIGS. 4a to 4c illustrate a seismograph, wind speed sensor or similar movement sensor embodying the present invention. A magnetic body (11) is suspended by the inertia of a magnetic field. The magnetic body has a counterweight (2) hanging from it and three energy take-off lines (3). Movement of the magnetic body can be monitored and/or measured by monitoring and/or measuring the energy taken-off at the bottom ends of the power or energy take-off lines (3).

For wind or vibration sensors, an energy interceptor (i.e. the magnetic body (11)) can be suspended using a mooring system (for example that described in co-pending patent application GB 1016388.9), thus being able to oscillate under a varying forcing. By attaching a counterweight (2) below the energy interceptor (11), we can give it a natural horizontal frequency of oscillation, which if in match with the oscillation of the energy source, can initiate resonance. For example, an array of these devices, each one with a different frequency of horizontal oscillation, can be used to build a sensor capable of detecting the frequency of oscillation in the speed of a wind or current stream. If the energy interceptors are weights magnetically suspended, such an array can detect very effectively seismic vibrations. If also the “counterweight” is magnetic, the natural plane of augmented (resonant) oscillation can be no longer only horizontal, and you can use an array of sensors to identify vibrations in all directions.

The description in this specification describes a number of different embodiments. These embodiments may include a particular combination of features. The skilled man appreciate that different combinations are possible within the scope of the invention.

1. Apparatus for converting movement into energy, comprising:
a buoyant or floating body fully submerged in a fluid medium, the buoyant body being supported in the fluid by a buoyancy or similar force acting in a first direction,
a connecting or mooring line connecting the buoyant body to a pivot point displaced from the buoyant body in the direction from which the buoyancy or similar force acts on the buoyant body, wherein the connecting or mooring line connects the buoyant body to a counterweight which forms the pivot at the pivot point, and the apparatus also includes
at least one power or energy take-off line separate from the connecting or mooring line to convert movement of the buoyant body into energy.

2. Apparatus according to claim 1 wherein the counterweight hangs below the buoyant body.

3. Apparatus according to claim 1 wherein the at least one power or energy take-off line is a line whose orientation has a significant component orthogonal to the direction from which the buoyancy or similar force acts on the buoyant body.

4. Apparatus according to claim 3 wherein the buoyancy or similar force acts on the buoyant body in a substantially vertical direction and the power or energy take-off line runs between the buoyant body and an energy take-off line fixing point displaced from the buoyant body in a direction having a significant horizontal component.

5. Apparatus according to claim 1 wherein there are at least three power or energy take-off elements.

6. Apparatus according to claim 1 wherein the connecting or mooring line may, when in use, be kept at a substantially constant length.

7. Apparatus according to claim 1 wherein the length of the connecting or mooring line may be controllably changed.

8. A wave energy converter including apparatus according to claim 1 and wherein the fluid medium is water.

9. Apparatus according to claim 1 wherein the buoyant or floating body is a kite and the fluid medium is air.

10. Apparatus according to claim 1 wherein the buoyant or floating body is a body containing magnetic material and the buoyancy or similar force is provided by one or more magnets.

11. Apparatus according to claim 10 in which the force acting on the counterweight is at least partially magnetic.

12. Apparatus according to claim 1 wherein the buoyant or floating body is a body containing electrically charged material and the buoyancy or similar force is an electrostatic force.

13. Apparatus according to claim 12 wherein the counterweight contains electrically charged material and the force acting on the counterweight is at least partially electrostatic.

14. A wave energy converter according to claim 8 wherein the buoyant body is larger than the counterweight and the combination of the buoyant body and counterweight is positively buoyant.

15. A wave energy converter according to claim 8 wherein the length of the connecting or mooring line is selected so that the natural frequency of oscillation of the pendulum formed by the oscillation of the buoyant body about the pivot point is close to or substantially the same as the frequency of waves incident on the buoyant body.

16. A kit of parts including the elements of the apparatus recited in claim 1.

17. Method for converting movement into energy, including the steps of:
providing a buoyant or floating body fully submerged in a fluid medium, the buoyant body being supported in the fluid by a buoyancy or similar force acting in a first direction,
providing a connecting or mooring line connecting the buoyant body to a pivot point displaced from the buoyant body in the direction from which the buoyancy or similar force acts on the buoyant body, wherein the connecting or mooring line connects the buoyant body to a counterweight which forms the pivot at the pivot point, and
providing at least one power or energy take-off line connected to the buoyant body and separate from the connecting or mooring line to convert movement of the buoyant body into energy.

18. (canceled)

19. (canceled)

20. (canceled)

21. (canceled)

22. (canceled)

23. (canceled)

24. (canceled)

25. (canceled)

26. (canceled)

27. Apparatus according to claim 1 wherein the power or energy take-off line is connected to the buoyant body and separate from the connecting or mooring line.
